(19) United States
(12) Patent Application Publication
(10) Pub. No.: US 2015/0347942 A1
(43) Pub. Date: Dec. 3, 2015

(54) SYSTEMS AND METHODS FOR RETAIL LABOR BUDGETING

(71) Applicant: KRONOS TECHNOLOGY SYSTEMS LIMITED PARTNERSHIP, Chelmsford, MA (US)

(72) Inventor: Chandan Adhikari, Westford, MA (US)

(21) Appl. No.: 14/718,195

(22) Filed: May 21, 2015

Related U.S. Application Data
(60) Provisional application No. 62/003,291, filed on May 27, 2014.

(51) Int. Cl. G06Q 10/06

(52) U.S. Cl. CPC G06Q 10/06312; G06Q 10/06315

(57) ABSTRACT

A computer implemented method for determining labor forecasts is described. The method includes determining a forecasted business demand in long time intervals based at least in part on historical business demand data. For each time interval in the forecasted business demand, a distribution of the associated forecasted business demand in short time intervals is determined. The method also includes determining forecasted labor hours in the long time intervals based at least in part on the forecasted business demand, the distribution of the associated forecasted business demand and labor standards. The labor standards are specified with respect to time intervals of the second length. A forecasted labor cost in long time intervals is determined based at least in part on the forecasted labor hours and wage rate data. Apparatus and computer readable media are also described.

### STATEMENT REGARDING FEDERALLY SPONSORED RESEARCH OR DEVELOPMENT

(Not Applicable)

### BACKGROUND

The present disclosure relates generally to systems and methods for determining a forecast or budget for labor amounts and costs for a business entity, and relates more particularly to systems and methods for determining a forecast or budget for labor amounts and costs for a business entity for a relatively small time interval with increased accuracy and efficiency.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

In retail or commercial operations, it is desirable to plan for amounts of labor needed for particular jobs and the cost of such labor. A large number of parameters are typically expected to influence the amount of labor and costs of such labor for particular jobs. The collection of data related to such parameters can be taken in 15 minute intervals, for example, which typically results in a large amount of data that can be used to fairly accurately forecast short term budgets for labor amounts and costs, e.g., on the order of months. However, for longer term planning, the amounts of data involved can prove to be impractical in terms of processing resources used to determine labor forecasts and in terms of processing performance used to obtain a result with a level of accuracy that is comparable with short term planning results.

Labor standards are specific to exact timespans, such as for or within a given day, and direct computation of labor at a typical fiscal period, such as a week, results in approximations that may not achieve a desired estimate accuracy. Accordingly, if labor requirements are computed for exact timespans as defined through labor standards, then this computation does not scale well for large enterprise retailers.

However, obtaining accurate forecasts for labor amounts and costs is typically crucial to practical applications for determining labor budgets. Accordingly, models for forecasting labor amounts and costs tend to sacrifice accuracy to reduce processing requirements, or tend to require significant resources to operate on the vast amount of data to obtain a desired level of accuracy. In large retail or commercial operations that may include hundreds or thousands of stores or business units, the cost of utilizing significant resources is typically outweighed and discarded in favor of reduced accuracy. Accordingly, it would be desirable to obtain a labor amount and cost budget forecast with a high degree of accuracy that does not utilize an impractical amount of resources.

In addition, the introduction of a technique for forecasting labor budgets preferably can reuse business entity configuration information or settings. A business entity often invests significant efforts and resources to develop business intelligence around configurations for determining labor forecasts, which intelligence is preferably not lost with the introduction of a new system or technique for forecasting labor budgets.

### BRIEF SUMMARY

The below summary is merely representative and non-limiting.

The above problems are overcome, and other advantages may be realized, by the use of the embodiments.

In accordance with the present disclosure, labor amounts and costs are generated on a highly granular basis in accordance with historical data to obtain an approximation budget or forecast for relatively small intervals of time for a labor related activity. For example, the intervals of time maybe as small as 15 (fifteen) minutes, and can include budget intervals of a day, a week, a month or a year, for example.

According to an aspect of the present disclosure, historical data is accessed and a measure of relevance of the historical data to the target interval is generated. The measure of relevance is combined with a seasonal adjustment or weighting to obtain a projected labor demand for the target interval. The budget amounts calculated for the various intervals can be combined, such as by being summed or proportioned, to obtain budgetary forecasts for larger intervals. For example, if the target interval is determined on a daily basis, weekly budget forecasts can be determined by combining the daily budgets. Such combinations of small interval budgets to obtain a larger interval budget increases the accuracy of the budget forecast.

In accordance with another aspect of the present disclosure, budget calculations can be made for a larger interval, based on smaller interval approximations, with the larger interval calculation data being stored along with a smaller interval percentage distribution to reduce the amount of resources used in generating a budget for a given interval. With this technique, the budgetary computation process can scale from relatively small enterprises to relatively large enterprises without the commitment of significant resources to obtain and manage such budgets. In addition, the technique permits horizontal scalability, where various budget calculation processes can be executed in parallel, for example, across multiple servers, platforms or locations.

### BRIEF DESCRIPTION OF THE SEVERAL VIEWS OF THE DRAWINGS

Aspects of the described embodiments are more evident in the following description, when read in conjunction with the attached Figures.

FIG. 1 is a block diagram of a process for calculating labor budgets for a particular job for a particular time period;

FIG. 2 is a block diagram of an improved process for calculating labor budgets for a particular job for a particular time period; and

FIG. 3 is a flow chart illustrating a process according to an exemplary embodiment of the present disclosure.

FIG. 4 shows a block diagram of a system and devices that are suitable for use in practicing various embodiments.

### DETAILED DESCRIPTION

This patent application claims priority under 35 U.S.C. §119(e) from U.S. Provisional Patent Application No.: 62/003,291, filed May 27, 2014, the disclosure of which is incorporated by reference herein in its entirety.

The presently disclosed systems and methods are implemented on one or more computer devices, such as networked servers (e.g. application servers), that can be connected to one or more databases that may or may not be distributed across logical or physical computing platforms, which database(s) house historical data. The disclosed systems and processes are thus configured to be run on processors coupled to memory devices that store instructions for execution by the processors. In accordance with advantages obtained by the disclosed systems and methods, operations can be carried out in parallel on different computer devices, such as networked servers (e.g. application servers), to achieve additional benefits, both in terms of processing performance and scalability.

In accordance with the present disclosure, systems and methods are presented for projecting or forecasting labor budgets, in terms of labor amounts and costs based on specific intervals of time. Inputs are obtained for projected business demands of labor, as well as predetermined labor standards for a given job activity which are related to the expected productivity of a worker for that job activity. The definition of a job activity can be significantly broad, and encompass a number of different tasks for a worker. For example, a job activity may be defined as sweeping a particular area of a retail or commercial building, or may be defined in terms of a purchase of a particular good or service, which may infer particular job activities, such as those implemented by a cashier or restocking person.

The expected productivity of a worker for a given job activity is provided as a labor standard for the particular job activity. The labor standards can be set by a business user, or can be provided as a general standard, such as by being based on national or local averages. With the inputs of budgetary forecasts and labor standards for particular job activities, a calculation can be performed to obtain a labor budget in terms of time, which can be specified on the order of days, weeks, months, quarters or years, for example. The specification of the labor budget and labor standards can be provided with respect to small discrete intervals, such as in 15 (fifteen) minute intervals. A business entity can thus obtain a labor budget for a given day, week, month or year to project labor demands and costs for those time periods. If a large business entity decides to obtain such forecasts for the organization as a whole, the amount of data can be extensive, computationally intense, and require significant resources while also exhibiting poor performance. Such a situation for such large retailers is not commercially feasible due to the high cost and low value in terms of performance for desired results.

The amount of data that is used to calculate such labor budgets on an entire organizational level can be vast, considering the number of workers, number of job activities possible and amount of data for each time interval for each potential job activity and worker. Accordingly, while budgetary forecasting with significant accuracy may be feasible for small scale business entities, the process does not scale well as more data is used in the case of larger scale business entities. It is possible to make approximations for some of the data for larger scale business entities, such as by providing data on a collective weekly basis, rather than for 15 (fifteen) minute intervals. However, the loss of accuracy in such approximations makes the resulting labor budget forecast less reliable to a large scale entity, even to the point where such labor budget forecasts are impractical in practice. Although there is a significant increase in performance in such systems that use approximation, the loss of accuracy is typically unacceptable, ranging, for example, from about 85 percent to about 90 percent accuracy.

In accordance with the present disclosure, systems and methods are provided to approximate labor budget forecasts for a small enough time interval to obtain a desired level of accuracy, such as, for example, 95 percent, while minimizing performance or resource penalties, to make the labor budget forecast practical for use with large scale business entities. The systems and methods of the present disclosure also seek to reuse institutional data/knowledge that has been developed over time, but may not be directly usable for generating the labor budget forecasts with the desired degree of accuracy.

According to an exemplary embodiment, daily interval labor budget estimates are calculated based on historical data. A prediction engine uses the historical data that can be broken up from a larger time interval, such as weekly, into smaller intervals, such as daily. The smaller time interval estimates based on historical data can be then be applied to the calculation involving the established labor standards for a larger time interval to determine a smaller time interval labor budget estimate. The historical data can be vast, and cover larger numbers of job activities and categories. The historical data can also be used to factor in such occurrences as may impact specific time intervals, such as in the case of certain shopping seasons during the year, certain holidays, certain promotional events, and any other factors that might influence variations for labor budget estimates on a day-to-day basis. The historical data can be of any desired length, such as a number of years, a number of months, a number of weeks, or a number of days. The historical data can also be used to pre-compute labor budget estimates for certain job activities, certain times of the year, certain months, weeks or days, including shopping seasons or holidays, for example. By pre-computing such data, the calculation of the labor budget forecast can be implemented with significantly increased efficiency over having to calculate a labor budget estimate on the basis of all available data, each time the calculation is performed.

The approximate calculations made for a given time interval labor budget forecast based on historical data can be applied in combination with the labor standards, or productivity rules, which define the productivity for given job activities to obtain a labor budget estimate for given job activities for the given time interval, such as on a daily bases. The labor standards or productivity rules can be modified to be more specific for a desired time interval, such as on a daily basis.

For example, a given job description may include a number of job activities, each of which may be assigned a particular productivity rule or labor standard. Some job activities may be specified on a weekly basis, and so are broken up into smaller approximations for use with a daily calculation, for example. Other job activities may be specified as occurring for a small period of time for certain days, even though the labor standards or productivity rules might specify such job activities for a weekly basis. Accordingly, the labor standards or productivity rules are configured to accept job activities that can be specified for a smaller interval of time, such as on a daily or 15 (fifteen) minute interval basis, for example.

The historical data upon which the daily labor budget estimates are calculated are updated on a daily basis to obtain the most current data for the calculations, thereby serving to increase the overall accuracy of the calculations. As discussed in greater detail below, the historical data is used to generate a relevance score for historical time intervals that correspond with a given target time interval for calculation of a labor budget estimate. The relevance score is combined with event data, which may represent particular events such as seasonal shopping, holidays or promotional events. The end result is an approximation for the target time interval for labor budget demands that can be used to approximate the labor budget for a given target time interval. With the labor budget estimate for the target time interval, labor standards or productivity rules can be applied to the labor budget estimate to obtain a time interval oriented labor budget estimate by job. When combined with wage rates per job or job activity, a result can be obtained for a labor budget and labor budget costs by job by time interval with a significant amount of accuracy to make the forecast useable by business entities that may vary significantly on a size scale.

According to an exemplary embodiment of the present disclosure, a fiscal period planning tool that generates long-term (annual, quarterly, monthly) sales and labor forecasts using historical business demand and wage data is presented. The planning tool uses configurations for sales and labor forecasts that can pre-exist for a given business entity to permit reuse of business entity intelligence and settings for sales and labor forecasts or planning. These forecasts can then be used as an annual budget or fiscal period plan, which can be used to constrain and monitor actual performance to period budget or period re-plan.

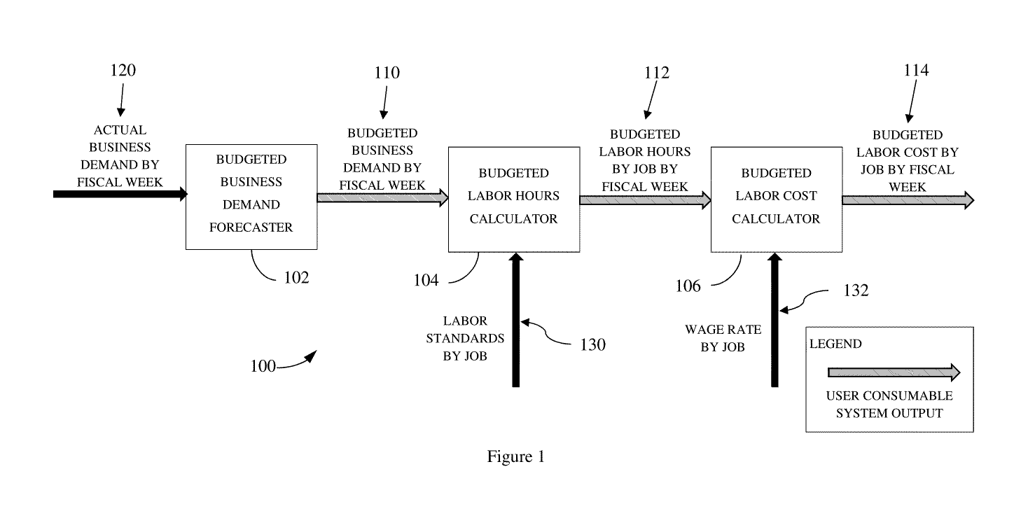

Referring now to FIG. 1, an exemplary embodiment of the present disclosure is illustrated as a process 100 for managing three types of budget data by pre-defined fiscal periods for general business entities.

The three types of budget data shown in process 100 are:

a) Projected business demands 110 (e.g., Sales and other types of business volumes)

b) Projected labor hours 112

c) Projected labor costs 114

All the above types of data can be managed for any fiscal periods such as fiscal day, week, month, quarter and/or year. However, according to an exemplary embodiment, all data is managed internally by the smallest possible fiscal period, e.g., a fiscal week, as illustrated in process 100.

Process 100 generates all three types of data by fiscal weeks for any desired fiscal period length up to a fiscal year using following mechanism:

1) Generation of projected business demand budget: A budgeted business demand forecaster component 102 uses an adaptive forecasting model for generating the business demand budgets using actual business demand 120 as input. Actual business demand 120 can be pre-consolidated by fiscal weeks through a different system process (not shown) (e.g. external to generation process) to contribute to efficient performance by component 102. According to an exemplary embodiment, the data is provided on the basis of a fiscal week, so that no smaller time interval data is processed.

2) Generation of projected labor hours budget: A budgeted labor hours calculator component 104 computes the projected labor hour budget by job and by fiscal weeks. Calculator component 104 makes the computations on projected business demand 110 and a labor standard configuration 130. Each labor standard 130 defines a smallest unit (e.g., in hours) of the work a particular job activity is expected to take to perform. The amount of effort in hours a job can take to perform each day is defined through one or more labor standards. Given projected business demands 110, labor standards 130 are essentially the computational rules, which may or may not be configured by the customers, to translate business demands into efforts spent in hours for a particular job activity to meet business demands 120. Since projected business demands 110 is provided on a weekly basis, the configuration data provided to calculator component 104 is typically specified for the same basis, which may tend to lose smaller interval data variations when collected into larger interval data.

3) Generation of projected labor cost budget: A budgeted labor cost calculator 106 computes a projected labor cost budget 114 by job and by fiscal week using the projected labor hour budget 112 by job and by fiscal week along with a wage rate by job 132. The wage rate by job can be an average pay rate by job, which can be determined in a number of different ways, including the following:

a. Calculation of average pay rate by job using actual payroll information from a timekeeping system such as the Kronos timekeeping system by Kronos Incorporated of Chelmsford, Mass.

b. Direct average pay rate configuration by job

The labor standards are originally designed based on the prevailing business practices, such as may be provided by retail industry concepts, for example, and are mainly suitable for computing labor hours for each 15 minutes interval of a given week. They are useful for creating a workload forecast (e.g., labor for each 15 minutes interval of a week) as originally designed for creating short term forecasts. It is desirable to reuse existing retail industry concepts for labor budgeting as much as possible to avoid business entities having to configure their systems to accommodate a new system, as may be implemented with the present disclosure. Accordingly, the existing labor standards concepts are reused for computing labor budgets from weekly projected business demands.

Consequently, calculations of budgeted labor hours 112 are based on business configurations that are modeled on a fiscal week rather than any smaller interval. Accordingly, to calculate budgeted labor hours for a fiscal day, budget hour calculator 104 is configured to use an approximate computation model to compute labor hours for a week directly instead of computing labor requirements at each 15 minutes interval of a week. This approximate computation model sometimes causes a relatively large variance compared with the short-term weekly labor forecast hours computed through a known short term planning tool, which uses an exact labor standards computation model. The fundamental reason for this discrepancy is related to how labor standards should be computed based on the definition of labor standards. There are essentially the following key types of labor standards:

a) Variable volume labor standards—these are the labor standards that are related to units of works, which depend on the projected business demands.

b) Ad-hoc volume labor standards—these are the labor standards that are related to units of works, which depend on ad-hoc or custom demands such as truck unloading or training hours etc.

c) Static volume labor standards—these are the labor standards that are related to units of works, which depend on the format of a retail store (ex. large, medium or small stores) such as sweeping store etc.

d) Fixed labor standards—these are the labor standards that are related to units of works, which depend on a list of efforts with fixed hours a job must accomplish.

Among all the above types of labor standards, the “variable volume labor standards” are most dependent on projected business demands and impacts overall accuracy of budgeted labor hour computation more prominently than other types of labor standards when the approximate computation model is used. However, for labor budgeting purposes, exact computation of labor standards, as is done for computing short-term labor forecasts, cannot be used within a long term, enterprise-wide planning tool, as it would adversely impact the overall runtime performance of the labor budget generation process due to tremendous increase in the volume of data (due to the size of actual business demand data per day). For example, the planning tool would process labor budgets for the whole retail enterprise comprising thousands of stores. However, unless the labor budget per week is within 5% of labor forecast from, for example, short term planning tools that use exact labor standards, for the same business demand, the process would not be sufficient for scheduling employees to organizational budgets for many enterprises.

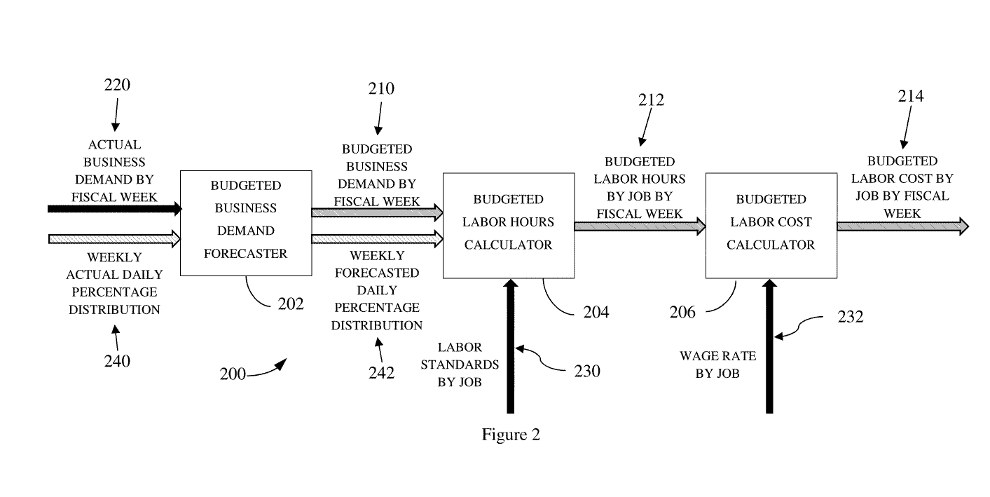

Referring now to FIG. 2 a diagram of an improved solution for computing an accurate labor budget without compromising the application performance and scalability goals is shown as process 200. Process 200 depicts components that are modified to generate particular data in particular ways to obtain greater accuracy without sacrificing significant levels of performance. Process 100 (FIG. 1) exhibits daily projected demand variation, since calculations are performed on a week-oriented basis, which may not be sufficiently accurate in the aggregate. Since daily variations are subsumed in the weekly calculations, the resulting labor budget forecasts may not capture the daily variations, leading to loss of accuracy based on a lack of consideration of the smaller interval data on its own. However, if the projected business demand is available by individual days of the week to the labor budget calculator, then a much more accurate labor budget can be computed. Even though applying daily projected business demand for calculating labor standards that are based on weekly time intervals results in an approximation, experimental results show that the objective of maximum 5% variance can be achieved for the same weekly projected business demands based on exact labor standards for short term planning.

When exact data is used, long term planning results in massive volumes of data. Effective management of large volumes of data for actual and projected business demands permits an efficient budget generation process. Computing projected daily business demands for a full fiscal year using actual daily business demands as input for computing budgets for a large enterprise is not only too inefficient performance-wise, but also demands much more system resources to store and manipulate data. However, if an accurate daily percentage distribution of the project business demand data by fiscal week is available to the labor hours calculator, as is the case in process 100, then a daily percentage distribution can be generated and used to find daily business demand through an in-memory computation process (e.g., significantly less resource use) and apply this information to calculate a more accurate labor hours budget. This change in process avoids storage and manipulation of a large volume of projected business demand data. This change also does not necessarily adversely impact runtime performance of either business demand or labor hours computation processes as most of the changes are within the in-memory computation process which can be scaled horizontally through parallel process execution across multiple servers and does not require any significant changes to processes related to data handling while running these computations.

Daily actual business demand information is used for computing accurate labor budget projections, which the presently disclosed systems and methods should be able to access efficiently. Accordingly, efficient access is provided by a sub-system that pre-computes and persists an actual percentage distribution 240 for a given time interval, such as daily, of any actual business demand for a fiscal week as a binary array along with an actual business demand by fiscal week 220. The binary array includes an input pair, e.g., weekly actual business demand 220 and weekly actual business demand daily percentage distribution 240, which is input to a budgeted business demand forecaster component 202. Component 202 uses weekly actual daily percentage distribution 240 for efficiently accessing and computing a daily actual business demand on the fly for further computation without incurring significant, if any, performance or scalability penalty.

To ensure that a projected weekly business demand 210 can be broken down to a daily level by component 202, a new daily volume distribution process is introduced. Weekly business demand 210 is displayed to the user rather than projected daily percentage distribution 242 of the weekly total. The user can thus edit projected business demand 210 without changing projected daily distributions 242.

The daily volume distribution process is essentially a heuristic process, which forecasts daily volume distribution percentages 242 by fiscal weeks. The process takes actual historical weekly daily distributions, for example, over a period of from 2 to 4 years (configurable), as input. The process calculates projected daily volume distribution 242 for each fiscal week during the projection period using a method described in the following sections.

The daily distribution process includes the following steps:
a) For each day of the fiscal week for which the process determines a daily percentage distribution:
   i. Calculate a relevance score for certain days in the available history that are considered relevant for computing projected daily business demand for the given day.
   ii. Determine the top scoring days that should be considered for computing daily business demand with high statistical confidence or correlation using the relevance score and seasonal score.
   iii. Calculate the projected business demand for the day.
b) Calculate projected daily business demand percentage 242 for the fiscal week The number of historical days for which relevance scores are computed is based on a configurable system setting and can vary in historical depth, such as, for example, between 2 to 4 years. The relevance score for any historical day with respect to any target day within the given fiscal week is impacted by several factors, including:
a) A day of the week score of the historical day relative to the given target day.
b) The event score of the historical day relative to the given target day.

The process calculates the day of the week score using the following domain dependent heuristics:
i. The absolute difference between any two days in the week (e.g., the target day of the week and the historical day of the week) ranges from 0.0 to 3.0.
ii. If this difference is zero, then both days are considered to be the same and the day of the week (DOW) score for the historical day is set to 100.00.
iii. If this difference is 1 or 2, then the assigned DOW score for the historical day is ⅓ or 33.33 for each incremental day of difference (e.g., 33.33 for difference of 1, 66.67 for difference of 2 etc.)
iv. If this difference is 3, then the assigned DOW score for the historical day is set to 0.00.

Users can assign special events to flag any day either in historical data or in the future to capture business anomalies (such as business promotional events, holidays etc. such as 4th of July) in the demand forecast. The daily distribution calculation process reuses the special event configuration and assigns an event score to the historical day based on the special event configuration. The event score is the ratio of total number of matching events (e.g., events that exist on both an actual historical day as well as a target day) to the total number of events found on the target day and actual historical day. If there is no match, or no event on either day, then this score is set to zero.

The DOW score and Event score for any actual historical day is combined to create a non-seasonal composite relevance score as follows:

Non-seasonal composite relevance score=DOW score*DOW score weightage+Event score*Event score weightage.

The DOW score weightage and the Event score weightage are configurable parameters selected by the user based on how much prominence should be given to selecting historical data for daily distribution computation based on day of the week compared with special events. The DOW weightage can vary from 50 to 100%. Correspondingly, the Event weightage can vary from 50 to 0%.

Since seasonality also plays a key role in predicting business demands under retail environments, the daily distribution process also considers a seasonal score component and combines the seasonal score with the non-seasonal composite score to calculate the final composite relevance score for any historical day. Through a separate configuration, the system allows the customer to divide their fiscal year into multiple seasons (for example, January-March, March-June, June-August, August-October, October-December). Using the concepts of various date ranges segmented by seasons both for prediction as well as for historical periods, the process decides the seasonal score for any given historical day as follows:

Seasonal score=100, if both the historical actual day and target day fall under the same season.

Seasonal score <100, if the historical actual day and the target day fall under different seasons. The exact score in this case will depend on how far away the actual day is compared with the target day.

The overall composite relevance score is calculated by combining the seasonal score and seasonal weightage with the non-seasonal composite relevance score. The seasonal weightage is defined by the customer through a configurable setting based on the assessment of how much relevance seasonality should have on business demand projection, and may vary from 0% to 100%, for example.

High relevance days are determined from a list of historical data points, which are most relevant for computing projected daily business demand for a given day within the fiscal week. The most relevant data points are selected from a group of historical data points with high relevance scores determined in accordance with the criteria discussed above. High relevance days are selected as those data points that have statistically high-confidence or high correlation for computation of daily business demand projection 242.

The daily projected business demand is computed by taking a weighted average of daily actual business demand. The weights for the weighted average are computed as the daily composite relevance scores for all statistically high-confidence relevance data points determined in accordance with the above technique. The user can configure a maximum number of high-confidence relevance data points that can be considered for this computation.

Once the projected daily business demand for each day of the fiscal week is determined, the daily percentage distribution for each day is determined as the ratio of projected daily business demand to the total weekly projected business demand 210. The result of the ratio determination is weekly forecasted daily percentage distribution 242, and is output from budgeted business demand forecaster 202. Distribution 242 is input into budgeted labor hours calculator 204, along with budgeted business demand by fiscal week 210.

Referring again to FIG. 1, budgeted labor hours calculator 104 includes configuration information developed by a business entity with time and resource expenditures, and is preferably maintained without significant or any change in the configuration information. For example, a business entity may build up business intelligence in the form of revised configurations of budgeted labor hours calculator 104 that reflects institutional knowledge about labor budgets and demand. Therefore, budgeted labor hours calculator 104 preferably is reused to continue to capture the business intelligence and institutional knowledge provided by the configuration in formation.

Referring again to FIG. 2, daily percentage distribution 242 provides budget data for a daily basis, while budgeted labor hours calculator 104 (FIG. 1) operates on weekly data. Accordingly, a modified budgeted labor hours calculator 204 is implemented in process 200 to accommodate daily data from daily percentage distribution 242, as well as daily-oriented data from labor standards 230. Budgeted labor hours calculator 204 thus calculates labor budgets for each day rather than directly for the whole week, as was the case with budgeted labor hours calculator 104. Calculator 204 operates by combining daily percentage distribution 242 with the weekly projected business demand, such as by multiplying the two together, to obtain the projected business demand for any specified day. Labor standards 230 can then also be applied on a daily basis by calculator 204 to arrive at budgeted labor hours by job by fiscal week 212, the output of calculator 204.

This calculation improves the accuracy of the projected labor hour budget for the fiscal week for several reasons. If the projected business demand for a day is less than what is necessary for maintaining the minimum or maximum staffing for the given day, then the minimum or maximum labor hours can be applied at the daily level properly. Similarly, the minimum or maximum staffing for any given day for other types of labor standards can also be applied more accurately when considered at the daily level.

A budgeted labor cost calculator 206 computes a projected labor cost budget 214 by job and by fiscal week using the projected labor hour budget 212 by job and by fiscal week along with a wage rate by job 232.

As described above, various embodiments provide a method, apparatus and computer program(s) to determine a forecast or budget for labor amounts and costs for a business entity for a relatively small time interval with increased accuracy and efficiency.

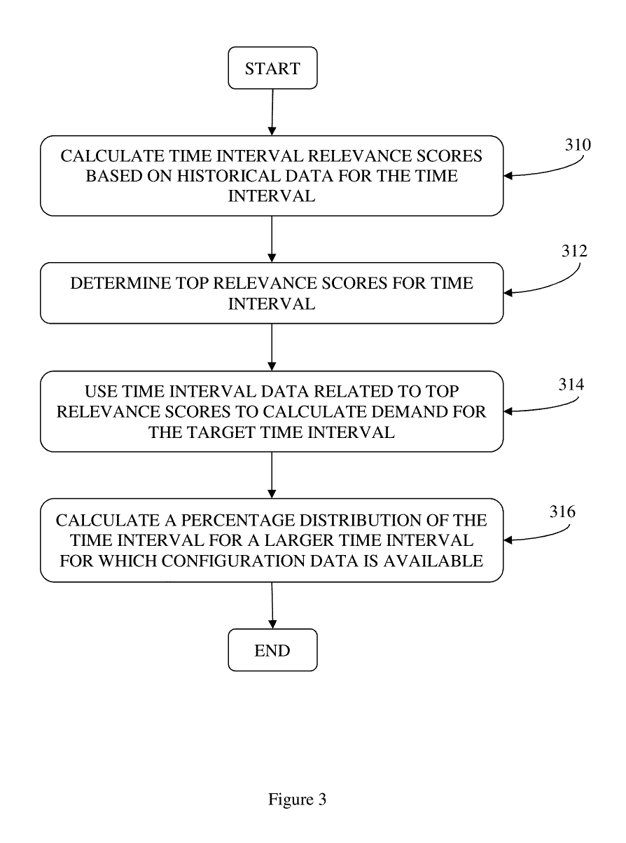

Referring now to FIG. 3, a flowchart 300 illustrates a process for determining percentage distribution 242. A block 310 illustrates the calculation of a relevance score for a given time interval based on historical data. This process is described above in greater detail for a time interval of a daily basis. Block 310 illustrates the concept of calculating relevance scores based on arbitrary time intervals using historical data for such time intervals. The relevance scores can take into account specific time intervals and specific events that can impact budgetary demands for the specific time interval, as well as such contributing factors as seasonality and particular characteristics of the target time interval. In addition, the time interval relevance scores can be calculated using weightings for the time interval, the relevant events for the time interval and for the seasonal impact, as is described in greater detail above with respect to a daily time interval.

A block 312 illustrates the determination of the top relevance scores for the specified time interval based on the historical data. The top relevance scores are used to determine the historical time interval data that can be used to predict budgetary labor demands for the target time interval with a statistically high degree of confidence or correlation, as illustrated in a block 314. The so identified historical time interval budgetary data is used to calculate the forecast demand for the target time interval, resulting in a calculation that more accurately reflects the budgetary demand for the time interval without significant loss of specificity for that time interval that might otherwise be obtained with approximations based on larger time interval data.

A block 316 illustrates the calculation of a percentage distribution of the time interval for a larger time interval for which configuration data is available. Once the time interval predicted demand is calculated, as illustrated in block 314, the ratio of that demand can be calculated for a larger time interval over which the target time interval is included. By utilizing a larger time interval, and determining the percentage distribution of the smaller time interval, factors specifically related to and developed for the larger time interval can be reused and applied without requiring new configuration data to be developed. As a result, a more efficient process for calculating labor budgets on a smaller time interval scale can be determined with greater accuracy for larger time interval budgetary forecasts without incurring significant performance or calculation resource penalties.

Business labor budget estimates for any location of an enterprise are computed using a projected business demand and labor standards defined for the location. These estimates are computed for any fiscal period up to a number of fiscal years, for example. However, a scalable solution for large enterprise retailers preferably computes the estimates directly for the given fiscal period. In the absence of practicality for performing computations using exact data, due to the volume of data, a workable approximation is proposed in the present disclosure. The proposed daily distribution process described herein is designed to compute an acceptably accurate labor budget hour estimate without compromising enterprise scalability and performance goals. It is essentially accomplished by first dynamically (in-memory) finding the daily percentages of the weekly projected business demands by fiscal weeks, creating an accurate in-memory daily estimates of labor requirements through a new labor standards computation model, and then rolling up the daily labor requirements to the overall fiscal period level (e.g., fiscal month, quarter or year) for business consumption.

An accurate labor budget modeling tool helps business entities ensure budgetary restrictions on labor costs is correctly applied for driving an automatic employee scheduling process. The present disclosure contributes to business entities being able to effectively manage their labor schedules to the projected business demands.

The various blocks shown in FIG. 3 may be viewed as method steps, as operations that result from use of computer program code, and/or as one or more logic circuit elements constructed to carry out the associated function(s).

The operations herein depicted and/or described herein are purely exemplary and imply no particular order. Further, the operations can be used in any sequence when appropriate and can be partially used. With the above embodiments in mind, it should be understood that they can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared and otherwise manipulated.

Any of the operations depicted and/or described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The disclosed systems and methods can also be embodied as computer readable code on a computer readable medium. The computer readable medium is any data storage device that can store data, which can be thereafter be read by a computer system. Examples of the computer readable medium include hard drives, read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

The foregoing description has been directed to particular embodiments of this disclosure. It will be apparent, however, that other variations and modifications may be made to the described embodiments, with the attainment of some or all of their advantages. The procedures, processes and/or modules described herein may be implemented in hardware, software, embodied as a computer-readable medium having program instructions, firmware, or a combination thereof. For example, the function described herein may be performed by a processor executing program instructions out of a memory or other storage device. Therefore, it is the object of the appended claims to cover all such variations and modifications as come within the true spirit and scope of the disclosure.

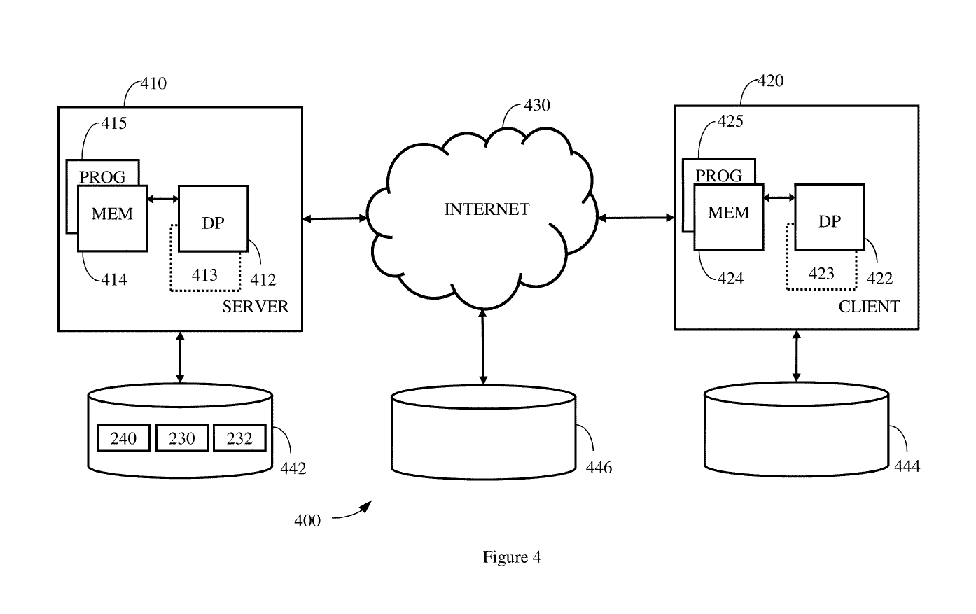

FIG. 4 shows a block diagram of a system 400 that is suitable for use in practicing various embodiments. In the system 400 of FIG. 4, the server 410 includes a controller, such as a data processor (DP) 412 and a computer-readable medium embodied as a memory (MEM) 414 that stores computer instructions, such as a program (PROG) 415. Server 410 may communicate with a client 420, for example, via the internet 430.

Client 420 includes a controller, such as a data processor (DP) 422 and a computer-readable medium embodied as a memory (MEM) 424 that stores computer instructions, such as a program (PROG) 425. Server 410 and/or client 420 may also include a dedicated processor, for example a labor forecasting processor 423.

Databases 442, 444, 446 may be connected directly to the server 410, the client 444 or the internet 430. As shown, database 442 stores actual percentage distribution 240, labor standards 230 and wage rate by job 232; however, this information may be stored separately (or together) in any of the databases 442, 444, 446.

The programs 415, 425 may include program instructions that, when executed by the DP 412, 422, enable the server 410 and/or client 420 to operate in accordance with an embodiment.

That is, various embodiments may be carried out at least in part by computer software executable by the DP 412 of the server 410, the DP 422 of the client 420, by hardware, or by a combination of software and hardware.

In general, various embodiments of the server 410 and/or client 420 may include tablets and computers, as well as other devices that incorporate combinations of such functions.

The MEM 414, 424 and databases 442, 444, 446 may be of any type suitable to the local technical environment and may be implemented using any suitable data storage technology, such as magnetic memory devices, semiconductor based memory devices, flash memory, optical memory devices, fixed memory and removable memory. The DP 412, 422 may be of any type suitable to the local technical environment, and may include general purpose computers, special purpose computers, microprocessors and multicore processors, as non-limiting examples.

An embodiment provides a computer implemented method for determining labor budget forecasts. The method is implemented with a processor that accesses a memory to obtain and execute instructions. The method includes accessing a database to obtain historical labor budget data for a specified time interval. One or more relevant time intervals are determined that correspond to a target time interval for which a labor budget is to be computed. The method also includes selecting statistically relevant time intervals and using the labor budget data associated with those selected time intervals to calculate a labor budget forecast for the target time interval. The labor budget forecast for the target time interval is applied to configuration data established for a larger time interval that encompasses the target time interval to obtain a labor budget forecast for the larger interval on the basis of the labor budget calculated for the target time interval.

Another embodiment provides a system for determining labor budget forecasts. The system includes a processor that is configured to accesses a memory to obtain and execute instructions. These instructions include to access a database to obtain historical labor budget data for a specified time interval. One or more relevant time intervals are determined that correspond to a target time interval for which a labor budget is to be computed. The instructions also include to select statistically relevant time intervals and calculate a labor budget forecast for the target time interval using the labor budget data associated with those selected time intervals. The labor budget forecast for the target time interval is applied to configuration data established for a larger time interval that encompasses the target time interval to obtain a labor budget forecast for the larger interval on the basis of the labor budget calculated for the target time interval.

A further embodiment provides a computer implemented method for determining labor budget forecasts. The method includes accessing historical business demand data. A forecasted business demand in time intervals having a first length is determined based on the historical business demand data. The method also includes, for each time interval in the forecasted business demand, determining a distribution of the associated forecasted business demand in time intervals having a second length, wherein the second length is shorter than the first length.

In another embodiment of the method above, the method also includes accessing labor standards, wherein the labor standards are specified with respect to time intervals of the second length; and determining forecasted labor hours in time intervals having the first length based on the forecasted business demand, the distribution of the associated forecasted business demand and the labor standards. The labor standards may include requirements for units of work. The method may also include accessing wage rate data; and determining a forecasted labor cost in time intervals having the first length based on the forecasted labor hours and the wage rate data.

In a further embodiment of any one of the methods above, the method also includes displaying the forecasted business demand; receiving edits to the forecasted business demand; and updating the forecasted business demand based on the edits.

In another embodiment of any one of the methods above, the first length is one of: one week, one month, one quarter, one season, and one year.

In a further embodiment of any one of the methods above, the second length is one of: fifteen minutes, one hour, and one day.

In another embodiment of any one of the methods above, the historical business demand data includes actual business demand data in time intervals having the first length and actual distribution of the associated actual business demand data in time intervals having the second length.

In a further embodiment of any one of the methods above, the method also includes determining actual business demand data in time intervals having the first length and actual distribution of the associated actual business demand data in time intervals having the second length based on the historical business demand data.

In another embodiment of any one of the methods above, determining the forecasted business demand includes for each time intervals having the second length, determining preliminary forecasted business demand data based on the historical business demand data; and combining a plurality of the preliminary forecasted business demand data into time intervals having the first length in order to generate forecasted business demand in time intervals having a first length. Determining the preliminary forecasted business demand data may include determining one or more relevant time intervals of the historical business demand data, the relevant time interval having the second length; and determining the preliminary forecasted business demand data based on the historical business demand data associated with the one or more relevant time intervals. Determining the one or more relevant time intervals may include, for each candidate time interval having the second length of the historical business demand data, calculating a relevance score for the candidate time interval; and selecting one or more top scoring candidate time intervals as the one or more relevant time intervals. Calculating the relevance score for the candidate time interval may be based on: a difference between which weekday is associated with the candidate time interval and which weekday is associated with the preliminary forecasted business demand data; a difference between which season is associated with the candidate time interval and which season is associated with the preliminary forecasted business demand data; whether the candidate time interval is associated with a business promotional event day; and/or whether the candidate time interval is associated with a holiday.

In a further embodiment of any one of the methods above, the distribution of the associated forecasted business demand indicates, for each component time interval having the second length in the time interval having the first length of the forecasted business demand, a percentage of the forecasted business demand attributed to the component time interval.

A further embodiment provides an apparatus for determining labor budget forecasts, such as a server or other computer system. The apparatus includes a processor and a memory storing computer program code. The memory and the computer program code are configured to, with the processor, cause the apparatus to perform actions. The actions include accessing historical business demand data. A forecasted business demand in time intervals having a first length is determined based on the historical business demand data. The actions also include, for each time interval in the forecasted business demand, determining a distribution of the associated forecasted business demand in time intervals having a second length, wherein the second length is shorter than the first length.

In another embodiment of the apparatus above, the actions also include accessing labor standards, wherein the labor standards are specified with respect to time intervals of the second length; and determining forecasted labor hours in time intervals having the first length based on the forecasted business demand, the distribution of the associated forecasted business demand and the labor standards. The labor standards may include requirements for units of work. The actions may also include accessing wage rate data; and determining a forecasted labor cost in time intervals having the first length based on the forecasted labor hours and the wage rate data.

In a further embodiment of any one of the apparatus above, the actions also include displaying the forecasted business demand; receiving edits to the forecasted business demand; and updating the forecasted business demand based on the edits.

In another embodiment of any one of the apparatus above, the first length is one of: one week, one month, one quarter, one season, and one year.

In a further embodiment of any one of the apparatus above, the second length is one of: fifteen minutes, one hour, and one day.

In another embodiment of any one of the apparatus above, the historical business demand data includes actual business demand data in time intervals having the first length and actual distribution of the associated actual business demand data in time intervals having the second length.

In a further embodiment of any one of the apparatus above, the actions also include determining actual business demand data in time intervals having the first length and actual distribution of the associated actual business demand data in time intervals having the second length based on the historical business demand data.

In another embodiment of any one of the apparatus above, determining the forecasted business demand includes for each time intervals having the second length, determining preliminary forecasted business demand data based on the historical business demand data; and combining a plurality of the preliminary forecasted business demand data into time intervals having the first length in order to generate forecasted business demand in time intervals having a first length. Determining the preliminary forecasted business demand data may include determining one or more relevant time intervals of the historical business demand data, the relevant time interval having the second length; and determining the preliminary forecasted business demand data based on the historical business demand data associated with the one or more relevant time intervals. Determining the one or more relevant time intervals may include, for each candidate time interval having the second length of the historical business demand data, calculating a relevance score for the candidate time interval; and selecting one or more top scoring candidate time intervals as the one or more relevant time intervals. Calculating the relevance score for the candidate time interval may be based on: a difference between which weekday is associated with the candidate time interval and which weekday is associated with the preliminary forecasted business demand data; a difference between which season is associated with the candidate time interval and which season is associated with the preliminary forecasted business demand data; whether the candidate time interval is associated with a business promotional event day; and/or whether the candidate time interval is associated with a holiday.

In a further embodiment of any one of the apparatus above, the distribution of the associated forecasted business demand indicates, for each component time interval having the second length in the time interval having the first length of the forecasted business demand, a percentage of the forecasted business demand attributed to the component time interval.

In another embodiment of any one of the apparatus above, the apparatus is embodied in a mobile device.

In a further embodiment of any one of the apparatus above, the apparatus is embodied in an integrated circuit.

Another embodiment provides a computer readable medium for determining labor budget forecasts. The computer readable medium is tangibly encoded with a computer program executable by a processor to perform actions. The actions include accessing historical business demand data. A forecasted business demand in time intervals having a first length is determined based on the historical business demand data. The actions also include, for each time interval in the forecasted business demand, determining a distribution of the associated forecasted business demand in time intervals having a second length, wherein the second length is shorter than the first length.

In a further embodiment of the computer readable medium above, the actions also include accessing labor standards, wherein the labor standards are specified with respect to time intervals of the second length; and determining forecasted labor hours in time intervals having the first length based on the forecasted business demand, the distribution of the associated forecasted business demand and the labor standards. The labor standards may include requirements for units of work. The actions may also include accessing wage rate data; and determining a forecasted labor cost in time intervals having the first length based on the forecasted labor hours and the wage rate data.

In another embodiment of any one of the computer readable media above, the actions also include displaying the forecasted business demand; receiving edits to the forecasted business demand; and updating the forecasted business demand based on the edits.

In a further embodiment of any one of the computer readable media above, the first length is one of: one week, one month, one quarter, one season, and one year.

In another embodiment of any one of the computer readable media above, the second length is one of: fifteen minutes, one hour, and one day.

In a further embodiment of any one of the computer readable media above, the historical business demand data includes actual business demand data in time intervals having the first length and actual distribution of the associated actual business demand data in time intervals having the second length.

In another embodiment of any one of the computer readable media above, the actions also include determining actual business demand data in time intervals having the first length and actual distribution of the associated actual business demand data in time intervals having the second length based on the historical business demand data.

In a further embodiment of any one of the computer readable media above, determining the forecasted business demand includes for each time intervals having the second length, determining preliminary forecasted business demand data based on the historical business demand data; and combining a plurality of the preliminary forecasted business demand data into time intervals having the first length in order to generate forecasted business demand in time intervals having a first length. Determining the preliminary forecasted business demand data may include determining one or more relevant time intervals of the historical business demand data, the relevant time interval having the second length; and determining the preliminary forecasted business demand data based on the historical business demand data associated with the one or more relevant time intervals. Determining the one or more relevant time intervals may include, for each candidate time interval having the second length of the historical business demand data, calculating a relevance score for the candidate time interval; and selecting one or more top scoring candidate time intervals as the one or more relevant time intervals. Calculating the relevance score for the candidate time interval may be based on: a difference between which weekday is associated with the candidate time interval and which weekday is associated with the preliminary forecasted business demand data; a difference between which season is associated with the candidate time interval and which season is associated with the preliminary forecasted business demand data; whether the candidate time interval is associated with a business promotional event day; and/or whether the candidate time interval is associated with a holiday.

In another embodiment of any one of the computer readable media above, the distribution of the associated forecasted business demand indicates, for each component time interval having the second length in the time interval having the first length of the forecasted business demand, a percentage of the forecasted business demand attributed to the component time interval.

In a further embodiment of any one of the computer readable media above, the computer readable medium is a storage medium.

In another embodiment of any one of the computer readable media above, the computer readable medium is a non-transitory computer readable medium (e.g., CD-ROM, RAM, flash memory, etc.).

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. It will be further appreciated by those of ordinary skill in the art that modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A computer implemented method comprising:
accessing historical business demand data;
determining a forecasted business demand in time intervals having a first length based at least in part on the historical business demand data; and
for each time interval in the forecasted business demand, determining a distribution of the associated forecasted business demand in time intervals having a second length, wherein the second length is shorter than the first length.

2. The method of claim 1, further comprising:
accessing labor standards, wherein the labor standards are specified with respect to time intervals of the second length; and
determining forecasted labor hours in time intervals having the first length based at least in part on the forecasted business demand, the distribution of the associated forecasted business demand and the labor standards.

3. The method of claim 2, wherein labor standards comprises requirements for units of work.

4. The method of claim 2, further comprising:
accessing wage rate data; and
determining a forecasted labor cost in time intervals having the first length based at least in part on the forecasted labor hours and the wage rate data.

5. The method of claim 1, further comprising:
displaying the forecasted business demand;
receiving edits to the forecasted business demand; and
updating the forecasted business demand based on the edits.

6. The method of claim 1, wherein the first length is one of: one week, one month, one quarter, one season, and one year.

7. The method of claim 1, wherein the second length is one of: fifteen minutes, one hour, and one day.

8. The method of claim 1, wherein the historical business demand data comprises actual business demand data in time intervals having the first length and actual distribution of the associated actual business demand data in time intervals having the second length.

9. The method of claim 1, further comprising:
determining actual business demand data in time intervals having the first length and actual distribution of the associated actual business demand data in time intervals having the second length based at least in part on the historical business demand data.

10. The method of claim 1, wherein determining the forecasted business demand comprises:
for each time intervals having the second length, determining preliminary forecasted business demand data based at least in part on the historical business demand data; and
combining a plurality of the preliminary forecasted business demand data into time intervals having the first length in order to generate forecasted business demand in time intervals having a first length.

11. The method of claim 10, wherein determining the preliminary forecasted business demand data comprises:
determining at least one relevant time interval of the historical business demand data, the relevant time interval having the second length; and
determining the preliminary forecasted business demand data based on the historical business demand data associated with the at least one relevant time interval.

12. The method of claim 11, determining the at least one relevant time interval comprises:
for each candidate time interval having the second length of the historical business demand data, calculating a relevance score for the candidate time interval; and
selecting at least one top scoring candidate time interval as the at least one relevant time interval.

13. The method of claim 12, wherein calculating the relevance score for the candidate time interval is based at least in part on at least one of:
a difference between which weekday is associated with the candidate time interval and which weekday is associated with the preliminary forecasted business demand data;
a difference between which season is associated with the candidate time interval and which season is associated with the preliminary forecasted business demand data;
whether the candidate time interval is associated with a business promotional event day; and
whether the candidate time interval is associated with a holiday.

14. The method of claim 1, wherein the distribution of the associated forecasted business demand indicates, for each component time interval having the second length in the time interval having the first length of the forecasted business demand, a percentage of the forecasted business demand attributed to the component time interval.

15. An apparatus, comprising at least one processor; and at least one memory including computer program code, the at least one memory and the computer program code configured to, with the at least one processor, cause the apparatus to perform at least the following:
to determine a forecasted business demand in time intervals having a first length based at least in part on historical business demand data;
for each time interval in the forecasted business demand, to determine a distribution of the associated forecasted business demand in time intervals having a second length, wherein the second length is shorter than the first length;
to determine forecasted labor hours in time intervals having the first length based at least in part on the forecasted business demand, the distribution of the associated forecasted business demand and labor standards, wherein the labor standards are specified with respect to time intervals of the second length; and
to determine a forecasted labor cost in time intervals having the first length based at least in part on the forecasted labor hours and wage rate data.

16. The apparatus of claim 15, wherein the at least one memory and the computer program code are further configured to cause the apparatus:
to display the forecasted business demand;
to receive edits to the forecasted business demand; and
to update the forecasted business demand based on the edits.

17. The apparatus of claim 15, wherein the at least one memory and the computer program code are further configured to cause the apparatus for each time intervals having the second length in the forecasted business demand:
for each candidate time interval having the second length of the historical business demand data, to calculate a relevance score for the candidate time interval;
to select at least one top scoring candidate time interval as at least one relevant time interval; and
to determine preliminary forecasted business demand data based on the historical business demand data associated with the at least one at least one top scoring candidate time interval; and
to combine a plurality of the preliminary forecasted business demand data into time intervals having the first length in order to generate forecasted business demand in time intervals having a first length.

18. A computer readable medium tangibly encoded with a computer program executable by a processor to perform actions comprising:
to determine a forecasted business demand in time intervals having a first length based at least in part on historical business demand data;
for each time interval in the forecasted business demand, to determine a distribution of the associated forecasted business demand in time intervals having a second length, wherein the second length is shorter than the first length;
to determine forecasted labor hours in time intervals having the first length based at least in part on the forecasted business demand, the distribution of the associated forecasted business demand and labor standards, wherein the labor standards are specified with respect to time intervals of the second length; and
to determine a forecasted labor cost in time intervals having the first length based at least in part on the forecasted labor hours and wage rate data.

19. The computer readable medium of claim 18,
displaying the forecasted business demand;
receiving edits to the forecasted business demand; and
updating the forecasted business demand based on the edits.

20. The computer readable medium of claim 18, for each time intervals having the second length in the forecasted business demand:
for each candidate time interval having the second length of the historical business demand data, calculating a relevance score for the candidate time interval;
selecting at least one top scoring candidate time interval as at least one relevant time interval; and
determining preliminary forecasted business demand data based on the historical business demand data associated with the at least one at least one top scoring candidate time interval; and
combining a plurality of the preliminary forecasted business demand data into time intervals having the first length in order to generate forecasted business demand in time intervals having a first length.
